(19) United States
(12) Patent Application Publication
(10) Pub. No.: US 2007/0271709 A1
(43) Pub. Date: Nov. 29, 2007

(54) Method and composition for avoiding staining during hair coloring

(76) Inventor: Richard King, Palm Harbor, FL (US)

Correspondence Address: MAYER & WILLIAMS PC, 251 NORTH AVENUE WEST, 2ND FLOOR, WESTFIELD, NJ, 07090, US

(21) Appl. No.: 11/786,429

(22) Filed: Apr. 11, 2007

Related U.S. Application Data
(60) Provisional application No. 60/791,000, filed on Apr. 11, 2006.

(51) Int. Cl. A61Q 5/00; C09K 3/00

(52) U.S. Cl. 8/405; 106/31.01

(57) ABSTRACT

A compound or mixture and a method are provided for preventing the coloring of hair or skin during a coloring procedure. The system may include two components: a compound that chemically protects the surface of the hair to which it is applied; and an applicator to accurately apply the compound to a region of the hair or skin that is desired to not be subject to the coloration procedure, in other words, to not be colored.

### STATEMENT OF RELATED APPLICATIONS

This application claims the benefit of U.S. Provisional Patent Application Ser. No. 60/791,000, filed Apr. 11, 2006, entitled “Method And Composition For Avoiding Staining During Hair Coloring”, which is incorporated by reference herein.

### FIELD OF THE INVENTION

The invention relates to skin and tissue protectors, and more particularly to compositions that protect skin and hair during artificial hair coloration procedures.

### BACKGROUND OF THE INVENTION

For personal and aesthetic reasons many people apply artificial coloring to all or a portion of their hair. A drawback of such artificial coloring is that its application is difficult to precisely control, i.e., the application is not always limited to the desired portion of the hair to be colored. Occasionally, the hair coloring chemicals flow to hair that is not desired to be colored or even to skin adjacent the hair.

### DETAILED DESCRIPTION OF THE INVENTION

In one embodiment, the invention includes two components: a compound that chemically protects the surface of the hair to which it is applied; and an applicator to accurately apply the compound to a region of the hair or skin that is desired to not be subject to the coloration procedure, in other words, to not be colored.

The compound, which may have the chemical structure of a mixture, may include a number of different sets of active ingredients. Such active ingredients may include petroleum jelly-based ingredients. Other active ingredients may include those disclosed in U.S. Pat. No. 5,500,218, which is herein incorporated by reference in its entirety, although other such chemical systems will be apparent to one of ordinary skill in the art given the teaching in this application. The consistency of such active ingredients may vary. Preferably the same will be semi-hard so as to hold a given shape but to be releasable in a smooth layer when rubbed on hair or skin, e.g., the consistency of a deodorant stick.

The compound may also have a number of different sets of inactive ingredients. That is, the active ingredients, if ones are chosen that do not per se have the proper semi-hard consistency, are bound into a chemical matrix of inactive ingredients that results in a combined consistency, e.g., similar to that of a solid stick-type deodorant or solid sunblock stick. The chemical matrix is termed herein the “inactive” ingredients but may in fact include elements or chemicals that assist in the hair or skin protection functionality. Certain such chemicals are disclosed in U.S. Pat. No. 6,409,997, which is herein incorporated by reference in its entirety, although other such chemical systems will be apparent to one of ordinary skill in the art given the teaching in this application.

The applicator is generally in the familiar form of a solid stick-type deodorant. In this way, unlike a spray-on or a cream that is applied by hand, the applicator may very accurately direct the application of the compound to any desired location. For example, if the hair coloring is to be applied to the totality of the hair, then the compound may be applied over the neck and shoulder areas, but not on the hair. If the hair coloring is to be applied over only certain parts of the hair, such as if hair highlights are being applied, then the compound may be applied over the neck and shoulder areas as well as over the areas over which hair coloring, e.g., highlights, are not to be applied.

Advantages of the invention include a significantly reduced clean-up time, a much more convenient clean-up, and less waste of hair coloring. Other advantages include a much more accurate application of hair coloring than in prior techniques.

In an application where all the hair is being colored, the user would use the applicator to apply the compound in areas adjacent the hairline and to any other areas that may be deleteriously affected by the hair coloring agents. The hair may then be colored in normal fashion. The compound may then be removed by washing the same off.

In an application where a portion of the hair is being colored, the user would use the applicator to apply the compound to any areas where hair coloring is not desired, as well as to areas adjacent the hairline and other areas that may be deleteriously affected by the hair coloring agents. This application is assisted by the increased accuracy of the applicator. The hair may then be colored in normal fashion. The compound may then be removed by washing the same off.

It should be noted that the compound may have a color marker or indicator incorporated within, such that the user may be able to easily see where the compound has been applied, and thus provide more accurate disposition of the compound.

The invention has been described with respect to certain embodiments. However, the scope of the invention is to be determined solely by the claims appended hereto.

1. A compound having a visual indication to prevent coloring of hair or skin, comprising:
a. a matrix ingredient having a consistency to maintain a given shape at room temperature but which is releasable in a smooth layer when rubbed on hair or skin;
b. a color ingredient which acts as a marker during application to notify the user of the locations where the compound has been applied.

2. The compound of claim 1, further comprising an active ingredient.

3. The compound of claim 2, wherein the active ingredient includes a petroleum product.

4. The compound of claim 1, wherein the compound has a stick shape.

5. A method for preventing coloring of hair or skin in a first area during a coloring procedure of a second area, comprising:
a. applying the compound of claim 1 to hair or skin in a first area;
b. coloring hair in a second area while the compound is disposed in the first area;
c. removing the coloring substance from the second area.
d. removing the compound from the first area.

6. The method of claim 5, further comprising an active ingredient.

7. The method of claim 6, wherein the active ingredient includes a petroleum product.

8. The method of claim 1, wherein the compound has a stick shape.
